(19) United States
(12) Patent Application Publication
(10) Pub. No.: US 2012/0019085 A1
(43) Pub. Date: Jan. 26, 2012

(54) ROTARY ELECTRIC MACHINE ARMATURE

(75) Inventors: Kiyotaka KOGA, Nishio (JP); Shogo MAEDA, Okazaki (JP)

(73) Assignee: AISIN AW CO., LTD., Anjo-shi (JP)

(21) Appl. No.: 13/161,566

(22) Filed: Jun. 16, 2011

(30) Foreign Application Priority Data
Jul. 22, 2010 (JP) 2010-165213

(51) Int. Cl. H02K 3/28

(52) U.S. Cl. 310/71

(57) ABSTRACT

A rotary electric machine armature that can be produced by a simplified manufacturing process and at a reduced manufacturing cost. The armature core includes a plurality of slots extending in the axial direction of a cylindrical core reference surface and are distributed in the circumferential direction of the core reference surface and a coil wound in the armature core. The coil is formed by joining a plurality of segment conductors to each other; each of the segment conductors includes a straight conductor side portion disposed in the slot, a parallel projecting portion extending in parallel with an extension direction of the conductor side portion to project in the axial direction from the armature core, and an oblique projecting portion provided opposite the parallel projecting portion in the axial direction and extending from the conductor side portion to project in the axial direction from the armature core.

### INCORPORATION BY REFERENCE

The disclosure of Japanese Patent Application No. 2010-165213 filed on Jul. 22, 2010 including the specification, drawings and abstract is incorporated herein by reference in its entirety.

### BACKGROUND OF THE INVENTION

The present invention relates to a rotary electric machine armature including an armature core in which a plurality of slots extending in the axial direction of a cylindrical core reference surface are distributed in the circumferential direction of the core reference surface and a coil wound in the armature core.

### DESCRIPTION OF THE RELATED ART

A technology which uses a coil formed by joining a plurality of segment conductors to each other as a rotary electric machine armature is known in the art. For example, Japanese Patent Application Publication No. 2000-299969 (pages 3 to 5 and FIGS. 3 and 10) below discloses a technology which uses a segment conductor including a straight portion to be received in a slot and oblique portions provided on both sides of the straight portion (on both sides in the axial direction of an armature core) to extend with an inclination in the circumferential direction with respect to the axial direction. Such a segment conductor, in which the oblique portions are formed on both sides of the straight portion, cannot be inserted into the slot of the armature core in the axial direction, and therefore is inserted into the slot from the radially inner side, after which the slot is processed to block an opening portion of the slot on the radially inner side. Japanese Patent Application Publication No. 2000-299969 (pages 3 to 5 and FIGS. 3 and 10) also discloses a technology which uses a segment conductor in which one of the oblique portions is not formed and which is inserted into a slot from the axial direction. In the case where such a segment conductor is used, after the segment conductor is inserted into the slot, a portion of the segment conductor that projects from the opposite side of the slot is bent to form another oblique portion. In the technologies disclosed in Japanese Patent Application Publication No. 2000-299969 (pages 3 to 5 and FIGS. 3 and 10), however, it is necessary to process the opening portion of the slot or a portion of the segment conductor after inserting the segment conductor into the slot. This tends to complicate the manufacturing process of the armature, and to increase the manufacturing cost.

Meanwhile, U.S. Pat. No. 6,870,294 (FIGS. 1a and 8) below discloses a technology which uses a segment conductor including a straight bar-like portion to be received in a slot and a plate-like connection portion formed at one end of the bar-like portion. In a configuration which uses such a segment conductor, the segment conductor can be inserted into a slot from the axial direction, and with a plurality of segment conductors inserted into slots, the plate-like connection portions of the segment conductors are arranged to overlap each other in the radial direction. Therefore, it is not necessary to process the segment conductors or the like after being inserted into the slots. However, it is necessary to crush a portion of the segment conductor itself into a plate-like shape in order to form the plate-like connection portion, which still tends to complicate the process of forming the segment conductor, and to increase the manufacturing cost.

### SUMMARY OF THE INVENTION

In view of the foregoing, it is desirable to provide a rotary electric machine armature that can be produced by a simplified manufacturing process and at a reduced manufacturing cost.

A rotary electric machine armature according to a first aspect of the present invention includes an armature core in which a plurality of slots extending in an axial direction of a cylindrical core reference surface are distributed in a circumferential direction of the core reference surface and a coil wound in the armature core. In the rotary electric machine armature, the coil is formed by joining a plurality of segment conductors to each other; each of the segment conductors includes a straight conductor side portion disposed in the slot, a parallel projecting portion extending in parallel with an extension direction of the conductor side portion to project in the axial direction from the armature core, and an oblique projecting portion provided opposite the parallel projecting portion in the axial direction and extending from the conductor side portion to project in the axial direction from the armature core, the oblique projecting portion being inclined in the circumferential direction with respect to the extension direction of the conductor side portion so as to gradually deviate from the armature core in the axial direction, and the oblique projecting portion extending from the conductor side portion to the parallel projecting portion of a joint-target segment conductor, which is another of the segment conductors as a joint target; a distal-end portion of the oblique projecting portion is joined to the parallel projecting portion of the joint-target segment conductor; and another of the segment conductors, the conductor side portion of which is disposed at the same position in a radial direction in an adjacent slot, serves as an adjacent same-layer segment conductor, and the oblique projecting portion of each of the segment conductors is disposed adjacently in parallel with and side by side at the same position in the radial direction as the oblique projecting portion of the adjacent same-layer segment conductor.

The term “rotary electric machine” as used herein refers to any of a motor (electric motor), a generator (electric generator), and a motor generator that functions both as a motor and as a generator as necessary. Also, the phrase “side by side at the same position in the radial direction” as used herein refers to a state of being arranged side by side at the same position in the radial direction of the core reference surface but consecutively displaced in the circumferential direction of the core reference surface.

According to the first aspect, each of the segment conductors includes the parallel projecting portion which is provided on one side of the straight conductor side portion to extend in parallel with the extension direction of the conductor side portion, and therefore the segment conductors can be inserted into the slots in the axial direction. Thus, it is possible to simplify the process of inserting the segment conductors into the slots. Moreover, it is not necessary to provide the armature core with an opening for insertion of the segment conductors in the radial direction. Therefore, it is possible to enhance the degree of freedom in shape of the slots. Each of the segment conductors also includes the oblique projecting portion which is provided opposite the parallel projecting portion to extend with an inclination in the circumferential direction with respect to the extension direction of the conductor side portion, and the distal-end portion of the oblique projecting portion is joined to the parallel projecting portion of the joint-target segment conductor. Therefore, the plurality of segment conductors can be joined to each other without processing, such as bending, the segment conductors. Thus, it is possible to simplify the manufacturing process of the rotary electric machine armature, and to reduce the manufacturing cost. Further, the oblique projecting portion of each of the segment conductors is disposed adjacently in parallel with and side by side at the same position in the radial direction as the oblique projecting portion of the adjacent same-layer segment conductor. Therefore, the oblique projecting portions of the plurality of segment conductors can be disposed at a high density without processing the oblique projecting portions or the like. Thus, it is possible to prevent a projecting portion of the coil, which projects from the armature core in the axial direction, from becoming larger in the radial direction and the axial direction. Hence, the size of the rotary electric machine armature can be reduced.

According to a second aspect of the present invention, one side and the other side of the core reference surface in the axial direction may serve as a first axial direction side and a second axial direction side, respectively, and the segment conductor, the conductor side portion of which is disposed in a first layer provided at a predetermined position in the radial direction in the slot, may serve as a first-layer segment conductor, and the segment conductor, the conductor side portion of which is disposed in a second layer provided adjacently on a radially inner side with respect to the first layer, may serve as a second-layer segment conductor, and the parallel projecting portion of the first-layer segment conductor and the oblique projecting portion of the second-layer segment conductor may be joined to each other on the first axial direction side with respect to the armature core, and the oblique projecting portion of the first-layer segment conductor and the parallel projecting portion of the second-layer segment conductor may be joined to each other on the second axial direction side with respect to the armature core.

According to the second aspect, the use of the segment conductors in two layers, namely the first-layer segment conductor and the second-layer segment conductor, makes it possible to form the coil by appropriately joining the plurality of segment conductors to each other without processing, such as bending, each of the segment conductors. This also allows a plurality of segment conductors in the same layer to have a common shape. Therefore, it is possible to reduce the number of types of the segment conductors and hence the manufacturing cost.

According to a third aspect of the present invention, the oblique projecting portion of the second-layer segment conductor may be disposed adjacently on a radially inner side of the parallel projecting portion of the first-layer segment conductor on the first axial direction side, and the oblique projecting portion of the first-layer segment conductor may be disposed adjacently on a radially outer side of the parallel projecting portion of the second-layer segment conductor on the second axial direction side.

According to the third aspect, it is not necessary for both the parallel projecting portion and the oblique projecting portion of each of the segment conductors to have a bent shape so as to be offset in the radial direction. Rather, such projecting portions can be disposed at the same position in the radial direction as the conductor side portion of each of the segment conductors. This makes it easy to simplify the shape of the projecting portions of the segment conductors, and makes it possible to reduce the manufacturing cost.

According to a fourth aspect of the present invention, the first-layer segment conductor may be inserted into the slot of the armature core along the axial direction from the second axial direction side with the parallel projecting portion at a leading head on the first axial direction side, and the second-layer segment conductor may be inserted into the slot of the armature core along the axial direction from the first axial direction side with the parallel projecting portion at a leading head on the second axial direction side.

According to the fourth aspect, the first-layer segment conductor and the second-layer segment conductor, in each of which the oblique projecting portion is formed on one side in the extension direction of the conductor side portion, can be appropriately inserted into the slots. After insertion of such segment conductors, the oblique projecting portion of the first-layer segment conductor is disposed on the second axial direction side with respect to the armature core, and the oblique projecting portion of the second-layer segment conductor is disposed on the first axial direction side with respect to the armature core. Thus, it is possible to achieve a configuration in which the parallel projecting portion of the first-layer segment conductor and the oblique projecting portion of the second-layer segment conductor are joined to each other on the first axial direction side with respect to the armature core, and in which the oblique projecting portion of the first-layer segment conductor and the parallel projecting portion of the second-layer segment conductor are joined to each other on the second axial direction side with respect to the armature core.

According to a fifth aspect of the present invention, the oblique projecting portion of the first-layer segment conductor and the oblique projecting portion of the second-layer segment conductor may be shaped to extend toward the same side in the circumferential direction of the core reference surface as each of the oblique projecting portions deviates from the armature core in the axial direction as seen from one side in the axial direction of the core reference surface.

According to the fifth aspect, a wave-wound coil can be formed by alternately joining the first-layer segment conductor and the second-layer segment conductor to each other.

According to a sixth aspect of the present invention, the parallel projecting portion may be formed in a shape of a straight line that is disposed on an extension line of the conductor side portion.

According to the sixth aspect, the shape of the segment conductors can be simplified with no need at all for a bending process or the like to form the parallel projecting portion. Thus, it is possible to reduce the manufacturing cost of the segment conductors.

According to a seventh aspect of the present invention, the oblique projecting portion may include a joint portion to be joined to the parallel projecting portion of the joint-target segment conductor, the joint portion may be formed to contact the parallel projecting portion of the joint-target segment conductor from one side in the radial direction, and to extend in parallel with an extension direction of the parallel projecting portion at the same position in the circumferential direction as the parallel projecting portion, and a main portion of the oblique projecting portion may be formed in a shape of a straight line that extends in an inclined direction with respect to the extension direction of the conductor side portion as seen in the radial direction of the core reference surface, and in a shape of an arc that is parallel with the core reference surface as seen in the axial direction of the core reference surface.

According to the seventh aspect, the joint portion of the oblique projecting portion and the parallel projecting portion of the joint-target segment conductor are disposed in parallel with each other and arranged side by side in contact with each other in the radial direction. Therefore, the segment conductors can be easily and reliably joined to each other. In addition, the main portion of the oblique projecting portion is disposed adjacently in parallel with and side by side at the same position in the radial direction as the oblique projecting portion of the adjacent same-layer segment conductor, and disposed in a cylindrical shape that matches the shape of the armature core. Therefore, the oblique projecting portions of the plurality of segment conductors can be disposed at a high density in such a shape that matches the shape of the armature without processing the oblique projecting portions or the like. Thus, it is possible to prevent a projecting portion of the coil, which projects from the armature core in the axial direction, from becoming larger in the radial direction and the axial direction. Hence, the size of the rotary electric machine armature can be reduced.

### BRIEF DESCRIPTION OF THE DRAWINGS

FIG. 1 is a perspective view showing the overall configuration of a stator according to an embodiment of the present invention;

FIG. 2 is a perspective view showing the shape of a pair of segment conductors that are joined to each other according to the embodiment of the present invention;

FIG. 3 is a development view showing the arrangement of segment conductors with respect to a stator core according to the embodiment of the present invention; and

FIG. 4 is a perspective view showing how the segment conductors are inserted into slots of the stator core according to the embodiment of the present invention.

### DETAILED DESCRIPTION OF THE EMBODIMENT

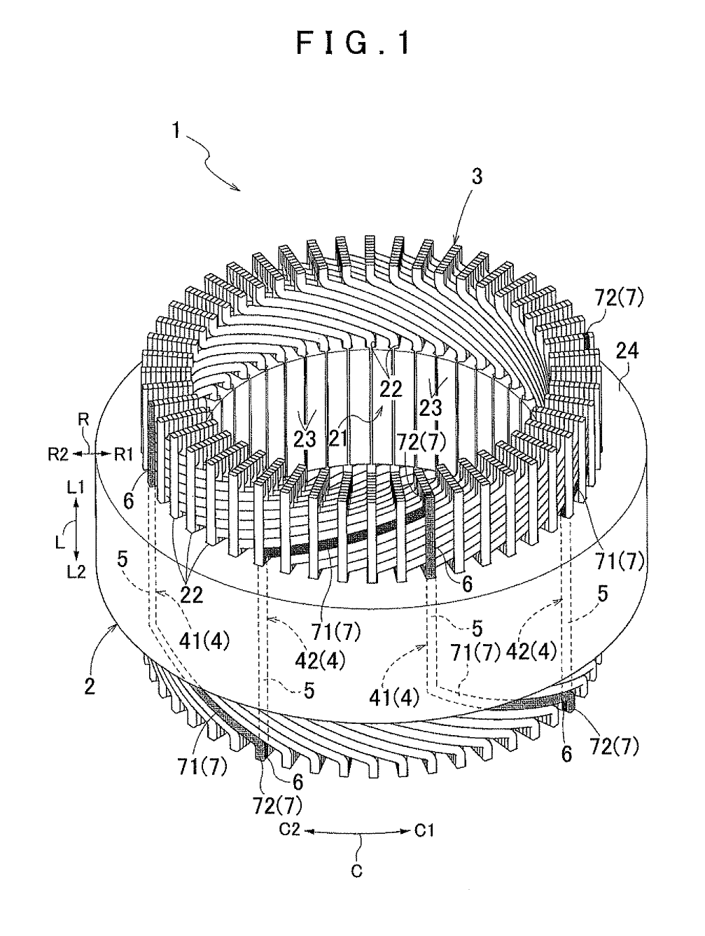

A rotary electric machine armature according to an embodiment of the present invention will be described with reference to the drawings. Here, the rotary electric machine armature according to the present invention is described as a stator 1 of a rotary electric machine of an inner rotor type. As shown in FIG. 1, the stator 1 according to the embodiment includes a stator core 2 and a coil 3 wound in the stator core 2. The coil 3 is formed by joining a plurality of segment conductors 4 to each other. The stator 1 is characterized in the shape and arrangement of the segment conductors 4. In the embodiment, the stator 1 and the stator core 2 are equivalent to the “rotary electric machine armature” and the “armature core”, respectively, according to the present invention. The configuration of the stator 1 according to the embodiment will be described in detail below.

In the description below, unless otherwise noted, an “axial direction L”, a “circumferential direction C”, and a “radial direction R” are defined with reference to the axis of a cylindrical core reference surface 21 to be discussed later. In the description below, a “first axial direction L1” indicates the upward direction along the axial direction L in FIG. 1, and a “second axial direction L2” indicates the downward direction along the axial direction L in FIG. 1. In the description below, as shown in FIG. 1, a “first circumferential direction C1” indicates the counterclockwise direction in the case where the stator 1 is seen from the first axial direction L1 side, and a “second circumferential direction C2” indicates the clockwise direction in the case where the stator 1 is seen from the first axial direction L1 side. A “radially inward direction R1” indicates the direction toward the inner side in the radial direction R of the core reference surface 21, and a “radially outward direction R2” indicates the direction toward the outer side in the radial direction R of the core reference surface 21. In the description below, directions regarding the coil 3 and the segment conductors 4 are defined with the coil 3 and the segment conductors 4 mounted to the stator core 2.
1. Overall Configuration of Stator

The overall configuration of the stator 1 according to the embodiment will be described with reference to FIG. 1. As shown in FIG. 1, the stator 1 includes the stator core 2 and the coil 3, and is formed as an armature for a rotary electric machine.

The stator core 2 is formed using a magnetic material. In the stator core 2, a plurality of (in the embodiment, 48) slots 22 extending in the axial direction L of the cylindrical core reference surface 21 are formed and distributed in the circumferential direction C of the core reference surface 21 so that the coil 3 can be wound in the stator core 2. Here, the “cylindrical core reference surface 21” refers to an imaginary surface serving as a reference for the arrangement and configuration of the slots 22. In the embodiment, as shown in FIG. 1, an imaginary cylindrical surface including end surfaces of teeth 23, which are positioned between the slots 22 which are adjacent to each other in the circumferential direction C, on the radially inward direction R1 side may be defined as a core inner circumferential surface, and such a cylindrical core inner circumferential surface may be the “cylindrical core reference surface 21” according to the present invention. A cylindrical surface (including an imaginary surface) which is concentric with the cylindrical core inner circumferential surface and whose cross-sectional shape as viewed in the axial direction L (as seen along the axial direction L) is similar to the cross-sectional shape of the core inner circumferential surface as viewed in the axial direction L may also serve as the “cylindrical core reference surface 21” according to the present invention. In the embodiment, as shown in FIG. 1, the stator core 2 is formed in a cylindrical shape, and therefore the outer circumferential surface of the stator core 2 may also be the “cylindrical core reference surface 21”, for example.

The stator core 2 has the plurality of slots 22 which are distributed in the circumferential direction C in a core main body. The plurality of slots 22 are disposed at predetermined intervals in the circumferential direction, and provided to extend at least in the axial direction L. In the embodiment, the slots 22 are each formed in the shape of a groove extending in the axial direction L and in the radial direction R and having a constant width in the circumferential direction C. In addition, each of the slots 22 is formed to open toward the radially inward direction R1 side (open in the core inner circumferential surface) and open toward both sides in the axial direction L of the stator core 2 (open in both end surfaces in the axial direction). Thus, in the stator core 2, the plurality of slots 22 are formed to extend radially in the radial direction R from the axis of the stator core 2. In addition, the plurality of slots 22 are formed to have the same shape as each other. A circumferential projecting portion that projects in the circumferential direction is formed at the distal-end portion of each of the teeth 23 so that the opening portion of each of the slots 22 on the radially inward direction R1 side is narrower in the circumferential direction C than that more on the radially outward direction R2 side.

In the embodiment, the stator 1 is a stator for use in a rotary electric machine that is driven by three-phase AC (U-phase, V-phase, and W-phase). Therefore, in the stator core 2, slots 22 for U-phase, V-phase, and W-phase are disposed to repeatedly appear along the circumferential direction C. In the embodiment, in the stator core 2, two slots 22 for U-phase which are adjacent to each other, two slots 22 for V-phase which are adjacent to each other, and two slots 22 for W-phase which are adjacent to each other are formed to repeatedly appear along the circumferential direction C in the order of mention so that the number of slots for each pole and for each phase is “two”. The coil 3 is also formed for three phases (U-phase, V-phase, and W-phase). In the embodiment, coils for the respective phases provided in the coil 3 have the same configuration as each other. Therefore, in the description below, the coils for the respective phases are described with no distinction unless distinction is necessary. In the embodiment, the coil 3 is wound in the stator core 2 by wave winding. In addition, the coil 3 is formed by joining the plurality of segment conductors 4 to each other as described in detail later.

Although not shown, a rotor including permanent magnets or electromagnets and serving as a field is disposed on the radially inward direction R1 side of the stator 1 (stator core 2) so as to be rotatable relative to the stator 1. A rotating magnetic field produced by the stator 1 rotates the rotor. That is, the stator 1 according to the embodiment serves as an armature for a rotary electric machine of an inner rotor type and of a rotating field type.

The stator core 2 described above can be formed as a laminated structure in which a plurality of magnetic steel plates each formed in an annular plate shape are laminated on each other, or using a compacted powder material formed from a powder magnetic material by pressure forming as a main constituent element, for example. Although the plurality of slots 22 are formed such that the number of slots for each pole and for each phase is “two” in the embodiment, it is a matter of course that the number of slots for each pole and for each phase may be changed appropriately. For example, the number of slots for each pole and for each phase may be “1” or “3”. In addition, the number of phases of an AC power supply that drives the rotary electric machine may also be changed appropriately, and may be “1”, “2”, or “4”, for example.
2. Configuration of Segment Conductors

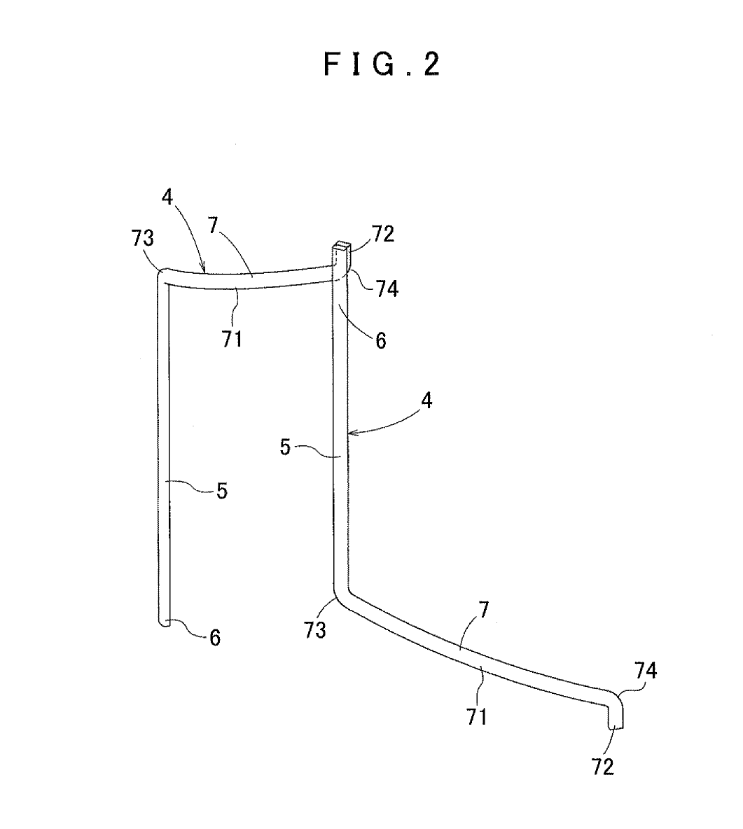

Next, each of the plurality of segment conductors 4 forming the coil 3 will be described. The segment conductor 4 is equivalent to a conductor obtained by dividing the coil 3 for each phase into a plurality of pieces. The coil 3 which encircles the stator core 2 is formed by joining end portions of the plurality of segment conductors 4 to each other. In the embodiment, as shown in FIGS. 1 and 2, the segment conductor 4 is formed by a linear conductor, and the shape of the cross-section of the linear conductor that is orthogonal to the extension direction (which is the same as the energization direction) is rectangular. The linear conductor 4 basically has the same cross-sectional shape at any position in the extension direction, except at bent portions 73 and 74. The linear conductor may be formed from a material such as copper or aluminum, for example. The surface of the linear conductor is coated with an insulating film made of a resin or the like (polyimide, for example), except at a portion of the linear conductor such as at a joint portion 72, which serves for electrical connection with another linear conductor 4.

In FIG. 1, which shows a state in which all the segment conductors 4 forming the coil 3 are wound in the stator core 2, only some of the segment conductors 4 are hatched, and portions of such segment conductors 4 that are hidden by the stator core 2 or other segment conductors 4 are indicated by broken lines. This is to facilitate understanding of the positional relationship of a plurality of segment conductors 4, among the large number of segment conductors 4, respective end portions of which are joined to each other. Meanwhile, FIG. 2 shows a pair of segment conductors 4 that are joined to each other. As shown in FIGS. 1 and 2, each of the segment conductors 4 includes a straight conductor side portion 5 disposed in the slot 22 and projecting portions that extend from the conductor side portion 5 to project in the axial direction L from the stator core 2, namely a parallel projecting portion 6 and an oblique projecting portion 7. Here, the parallel projecting portion 6 is a projecting portion that extends in parallel with the extension direction of the conductor side portion 5. The oblique projecting portion 7 is a projecting portion that is provided opposite the parallel projecting portion 6 in the axial direction L, while the oblique projecting portion 7 is inclined in the circumferential direction C with respect to the extension direction of the conductor side portion 5 so as to gradually deviate from the stator core 2 in the axial direction L, and extends from the conductor side portion 5 to the parallel projecting portion 6 of another segment conductor 4 as the joint target. In the description below, for a target segment conductor 4, another segment conductor 4, the conductor side portion 5 of which is disposed in an adjacent slot 22 and at the same position in the radial direction R is referred to as an “adjacent same-layer segment conductor”. Also, for a target segment conductor 4, another segment conductor 4 that is to be joined to the target segment conductor 4 is referred to as a “joint-target segment conductor”.

The conductor side portion 5 is a portion of the segment conductor 4 that is to be inserted into the slot 22 of the stator core 2, and has a shape that conforms to the shape of the slot 22. Here, as shown in FIGS. 1 and 2, the conductor side portion 5 is formed in the shape of a straight line that extends in parallel with the axial direction L. The conductor side portion 5 is disposed in the slot 22 in such an orientation that the short sides of the rectangular cross section of the linear conductor that is orthogonal to the extension direction are parallel with the radial direction R and the long sides of the rectangular cross section are substantially parallel with the circumferential direction C. As discussed later, a plurality of conductor side portions 5 (in the embodiment, ten conductor side portions 5) are disposed in a row in each of the slots 22 to overlap each other in the radial direction R so as to be arranged side by side at the same position in the circumferential direction C.

As shown in FIG. 1, each of the segment conductors 4 includes a pair of projecting portions that extend from the conductor side portion 5 to project toward one side in the axial direction L and toward the other side in the axial direction L, respectively, from the stator core 2. Specifically, as shown in FIGS. 1 and 2, each of the segment conductors 4 includes the parallel projecting portion 6 which extends toward one side in the axial direction L from the conductor side portion 5 and the oblique projecting portion 7 which extends toward the other side in the axial direction L. The parallel projecting portion 6 is formed to extend in parallel with the axial direction L, which is the extension direction of the conductor side portion 5, at the same position in the circumferential direction C as the conductor side portion 5. In the embodiment, the parallel projecting portion 6 is formed in the shape of a straight line that is disposed on the extension line of the conductor side portion 5, that is, formed to be collinear with the conductor side portion 5. Thus, the parallel projecting portion 6 is formed without processing, such as bending, the conductor side portion 5. The distal-end portion of the parallel projecting portion 6, which contacts the joint portion 72 of the oblique projecting portion 7 to be discussed later, serves as a joint portion of the parallel projecting portion 6.

As shown in FIG. 1, the oblique projecting portion 7 is provided opposite the parallel projecting portion 6 in the axial direction L, and formed to project from the stator core 2. The oblique projecting portion 7 is inclined in the circumferential direction C with respect to the extension direction of the conductor side portion 5 so as to gradually deviate from the stator core 2 in the axial direction L, and formed to extend from the conductor side portion 5 to the parallel projecting portion 6 of the joint-target segment conductor. Here, the oblique projecting portion 7 is formed to extend in an inclined direction with respect to the extension direction of the conductor side portion 5 so as to extend toward either side in the circumferential direction C as the oblique projecting portion 7 deviates from the stator core 2 in the axial direction L. In the embodiment, in addition, the oblique projecting portions 7 of all the segment conductors 4 are shaped to extend toward the same side in the circumferential direction C, specifically toward the first circumferential direction C1 side, as the oblique projecting portions 7 deviate from the stator core 2 in the axial direction L. The distal-end portion of the oblique projecting portion 7 is joined to the parallel projecting portion 6 of the joint-target segment conductor. Therefore, the distal-end portion of the oblique projecting portion 7 serves as the joint portion 72 which is disposed at a position at which the oblique projecting portion 7 contacts the parallel projecting portion 6 of another segment conductor 4 as the joint target (joint-target segment conductor) to be joined to the parallel projecting portion 6. Meanwhile, a portion of the oblique projecting portion 7 that extends in the circumferential direction C along an inclined direction with respect to the extension direction of the conductor side portion 5 from the same position in the circumferential direction C as the conductor side portion 5 to the joint portion 72 serves as a main portion 71.

In the oblique projecting portion 7, as shown in FIG. 2, the bent portions 73 and 74 are formed between the main portion 71 and the conductor side portion 5 and between the main portion 71 and the joint portion 72, respectively. Here, the bent portion between the main portion 71 and the conductor side portion 5 serves as a first bent portion 73, and the bent portion between the main portion 71 and the joint portion 72 serves as a second bent portion 74. The first bent portion 73 is a bent portion for forming the main portion 71 of the oblique projecting portion 7 by bending one of the projecting portions of the segment conductor 4 so as to extend in an inclined direction with respect to the extension direction of the conductor side portion 5. The second bent portion 74 is a bent portion for forming the joint portion 72 of the oblique projecting portion 7 by bending the distal-end portion of the oblique projecting portion 7 so as to extend in an inclined direction with respect to the main portion 71 and in parallel with the parallel projecting portion 6 of the joint-target segment conductor.

As described above, the oblique projecting portion 7 includes the main portion 71 and the joint portion 72. As shown in FIGS. 1 and 2, the main portion 71 is a straight portion that extends in an inclined direction with respect to the extension direction of the conductor side portion 5 as seen in the radial direction R. Here, the main portion 71 is formed to extend in an inclined direction in the circumferential direction C with respect to the extension direction of the conductor side portion 5 by bending a straight portion disposed on the extension line of the conductor side portion 5 at the first bent portion 73 in the circumferential direction C. The inclination angle of the extension direction of the main portion 71 is preferably set to an angle of 45° or more and less than 90°, more preferably an angle of 60° or more and less than 90°, with reference (0°) to the direction of extending in parallel with the extension direction of the conductor side portion 5 (axial direction L) and away from the stator core 2. Further, the inclination angle is preferably set to the largest angle, that is, the closest angle to the direction in parallel with an axial end surface 24 of the stator core 2, within a range where the first bent portion 73 or the main portion 71 of the adjacent same-layer segment conductor does not interfere with the segment conductor 4 targeted herein. With such a configuration, the height of coil end portions, which are projecting portions of the coil 3 that project from the stator core 2 in the axial direction L, can be restricted to a minimum.

As discussed later, the joint portion 72 of the oblique projecting portion 7 is disposed to contact the parallel projecting portion 6 of the joint-target segment conductor from one side in the radial direction R at the same position in the circumferential direction C as the parallel projecting portion 6. Thus, the extension length of the main portion 71 in the circumferential direction C is set such that the joint portion 72 is disposed at such a position. In the embodiment, as shown in FIG. 1, the joint portion 72 of each of the segment conductors 4 is joined to the parallel projecting portion 6 of the joint-target segment conductor which is disposed in the slot 22 located six slot pitches away in the circumferential direction C (here, in the first circumferential direction C1) from the slot 22 in which the conductor side portion 5 of that segment conductor 4 is disposed. That is, the conductor side portion 5 and the joint portion 72 of each of the segment conductors 4 are disposed at an interval corresponding to six slot pitches in the circumferential direction C. Thus, the extension length of the main portion 71, which extends from the boundary portion with the conductor side portion 5 to the joint portion 72, in the circumferential direction C is set to a length corresponding to six slot pitches. Accordingly, the oblique projecting portion 7 is formed to extend from the conductor side portion 5 to the parallel projecting portion 6 of the joint-target segment conductor. Here, the extension length of each portion corresponds to a length in the circumferential direction C obtained by projecting that portion onto a plane that is orthogonal to the axial direction L.

In the embodiment, further, the main portion 71 is formed in the shape of an arc that is parallel with the core reference surface 21 as seen in the axial direction L. That is, the main portion 71 is shaped to be inclined away from the stator core 2 in the axial direction L and to be curved along the core reference surface 21 from the conductor side portion 5 side toward the joint portion 72 side. Accordingly, the main portion 71 is disposed along a cylindrical surface that is parallel with the core reference surface 21 so as to extend in the circumferential direction C through the same position in the radial direction R (through the same layer in the slot 22) as the conductor side portion 5 of the segment conductor 4. Thus, the main portion 71 is disposed without interference with the respective parallel projecting portions 6 of other segment conductors 4 that exist on both sides in the radial direction R. That is, in the embodiment, as shown in FIG. 1, the main portion 71 of each of the segment conductors 4 is formed to extend over a distance corresponding to six slot pitches in the circumferential direction C from the boundary portion with the conductor side portion 5 to the joint portion 72. The main portion 71 of each of second-layer to ninth-layer segment conductors 4, excluding a first-layer segment conductor 41 that is on the outermost side in the radial direction R and a tenth-layer segment conductor that is on the innermost side in the radial direction R, is disposed to extend in the circumferential direction C, and sandwiched by the parallel projecting portions 6 of other segment conductors 4, which are inserted into each of the slots 22 between the boundary portion with the conductor side portion 5 and the joint portion 72, from the radially outward direction R2 side and the radially inward direction R1 side. The parallel projecting portions 6 of the other segment conductors 4 sandwiching the main portion 71 are disposed along an arc that is parallel with the core reference surface 21 in accordance with the shape of the slots 22. Hence, the main portion 71 shaped as described above can be disposed without interference with the parallel projecting portions 6 of the other segment conductors 4.

The joint portion 72 of the oblique projecting portion 7 is disposed at a position at which the oblique projecting portion 7 contacts the parallel projecting portion 6 of the joint-target segment conductor to be joined to the parallel projecting portion 6. The distal-end portion of the oblique projecting portion 7, that is, an end portion area of the oblique projecting portion 7 that is opposite the conductor side portion 5, serves as the joint portion 72. In the embodiment, as shown in FIG. 2, the joint portion 72 is formed by bending the main portion 71 at the second bent portion 74 so as to extend in an inclined direction with respect to the extension direction of the main portion 71 and in parallel with the extension direction of the parallel projecting portion 6 of the joint-target segment conductor. Thus, the joint portion 72 is formed in the shape of a straight line that extends in a direction in parallel with the axial direction L, as with the parallel projecting portion 6. The joint portion 72 is disposed to contact the parallel projecting portion 6 of the joint-target segment conductor from one side in the radial direction R and at the same position in the circumferential direction C as the parallel projecting portion 6. Such an arrangement of the joint portion 72 is set by the length of the main portion 71 in the circumferential direction C as described above. The joint portion 72 is not bent to be different in position in the radial direction R from the main portion 71. Therefore, the joint portion 72 is disposed at the same position in the radial direction R as the main portion 71. Thus, the entire oblique projecting portion 7, which includes the main portion 71 and the joint portion 72, is disposed at the same position in the radial direction R (in the same layer in the slot 22) as the conductor side portion 5 of the segment conductor 4.

The shape of each of the segment conductors 4 has been described above. The plurality of segment conductors 4 which are wound in the stator core 2 are slightly different in shape from each other depending on the location in the radial direction R with respect to the stator core 2. That is, the plurality of slots 22 are provided to extend radially from the axis of the stator core 2 such that the intervals between the slots 22 in the circumferential direction C become wider toward the radially outward direction R2 side. As described above, the oblique projecting portion 7 is formed to extend from the conductor side portion 5 to the parallel projecting portion 6 of the joint-target segment conductor, and therefore the conductor side portion 5 and the joint portion 72 of each of the segment conductors 4 are formed to be located a predetermined number of slot pitches (here, six slot pitches) away from each other in the circumferential direction C. Thus, the extension length of the main portion 71 in the circumferential direction C is set in accordance with such an interval between the conductor side portion 5 and the joint portion 72 in the circumferential direction C. The extension length of the main portion 71 becomes longer as the main portion 71 is disposed more on the radially outward direction R2 side with respect to the stator core 2. Thus, the segment conductor 4 which is disposed on the radially outward direction R2 side (in a layer on the radially outer side in the slot 22) in the stator core 2 is formed such that the length, in the circumferential direction C, of the main portion 71 forming the oblique projecting portion 71 of the segment conductor 4 is longer than that of the segment conductor 4 disposed more on the radially inward direction R1 side (in a layer on the radially inner side in the slot 22). Otherwise, the plurality of segment conductors 4 basically have the same shape as each other. The plurality of segment conductors 4 which are disposed at the same position in the radial direction R with respect to the stator core 2 have the same shape as each other.
3. Configuration of Coil

Next, the configuration of the coil 3 according to the embodiment will be described in detail. As shown in FIG. 1, the coil 3 is formed by joining the plurality of segment conductors 4 shaped as described above to each other. In the embodiment, the plurality of segment conductors 4 are successively joined to each other such that the coil 3 is wound in the stator core 2 by wave winding. The coil 3 is wound in the stator core 2 with the conductor side portions 5 of the plurality of segment conductors 4 forming the coil 3 respectively disposed in the plurality of slots 22 formed in the stator core 2.

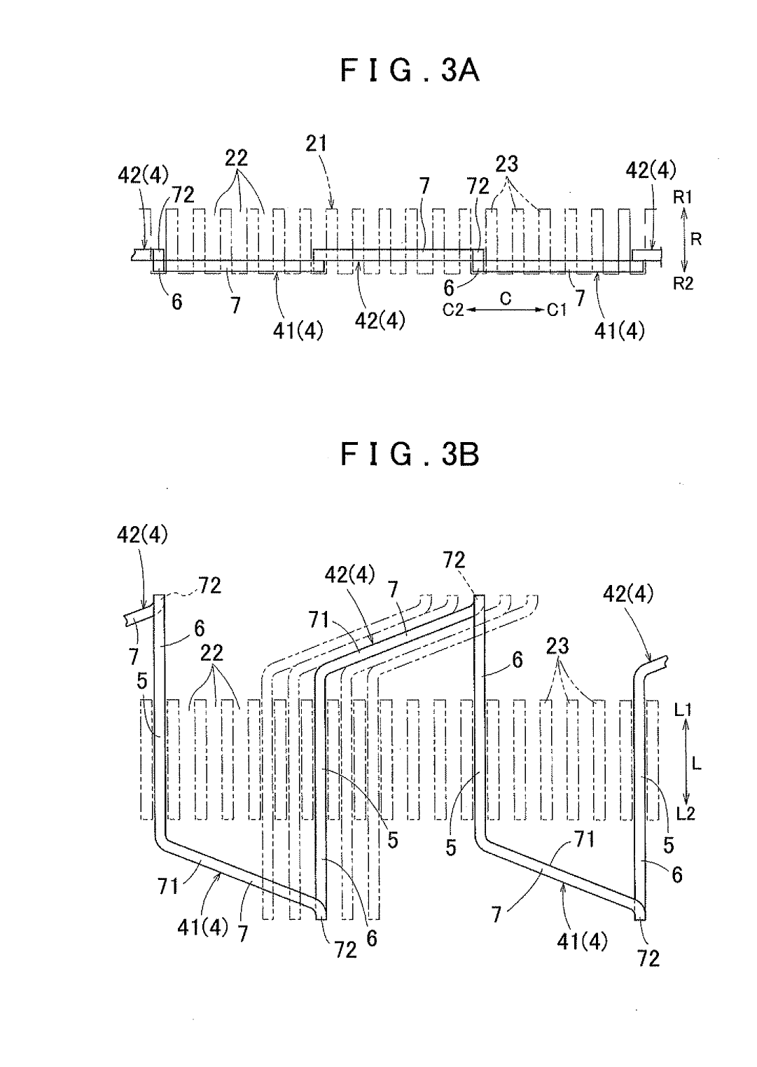

In each of the slots 22, n conductor side portions 5 of the segment conductors 4 are arranged in the radial direction R to form an n-layer winding structure. Here, n is an integer of 2 or more (particularly preferably an even number), and is set in accordance with the magnitude of torque required from the rotary electric machine or an allowable counter-electromotive force or the like. In the embodiment, the coil 3 has a ten-layer winding structure, and ten conductor side portions 5 are disposed in a row in each of the slots 22 to overlap each other in the radial direction R so as to be arranged side by side at the same position in the circumferential direction C. In the embodiment, the position of the conductor side portion 5 in each of the slots 22 that is most on the radially outward direction R2 side serves as a first layer, and the respective positions of the other conductor side portions 5 sequentially serve as a second layer, a third layer, . . . , and a tenth layer from the first-layer side toward the radially inward direction R1 side. In addition, the segment conductor 4, the conductor side portion 5 of which is disposed in the first layer in the slot 22, serves as the first-layer segment conductor 41, and the segment conductor 4, the conductor side portion 5 of which is disposed in the second layer, serves as a second-layer segment conductor 42. Likewise, the other segment conductors 4 serve as a third-layer segment conductor, a fourth-layer segment conductor, . . . , and a tenth-layer segment conductor depending on the layer in which the conductor side portion 5 of the segment conductor 4 is disposed. In FIG. 1, in order to improve the viewability of the drawing, joint portions for forming neutral points, connection portions for connection with a terminal for connection to the power supply, differently shaped segment conductors for forming these portions, and so forth are not shown. In FIG. 3, in order to show the arrangement of the segment conductors 4 with respect to the stator core 2 in an easily understandable manner, the slots 22 of the stator core 2 and the segment conductors 4 are shown with the core reference surface 21 developed onto a plane. FIG. 3 shows only some of the plurality of segment conductors 4, that is, some of the first-layer segment conductors 41 and the second-layer segment conductors 42. FIG. 3A is a view as seen from the first axial direction L1 side, and FIG. 3B is a view as seen from the radially outward direction R2 side.

In the stator core 2, as described above, two slots 22 for U-phase which are adjacent to each other, two slots 22 for V-phase which are adjacent to each other, and two slots 22 for W-phase which are adjacent to each other are formed to repeatedly appear along the circumferential direction C in the order of mention. In the embodiment, as shown in FIG. 1, for each of the segment conductors 4, the segment conductor 4, the conductor side portion 5 of which is disposed in the slot 22 which is located six slot pitches away in the circumferential direction C (here, the first circumferential direction C1) from the slot 22 in which the conductor side portion 5 of the each segment conductor 4 is disposed, serves as the joint-target segment conductor, in view of such an arrangement of the slots 22. In other words, the conductor side portion 5 of each of the segment conductors 4 and the conductor side portion 5 of the joint-target segment conductor which is to be joined to that segment conductor 4 are respectively disposed in a pair of slots 22 that are spaced from each other in the circumferential direction C by a distance that is equivalent to one magnetic pole pitch (an electrical angle of π).

In the embodiment, odd-number-layer segment conductors and even-number-layer segment conductors are alternately joined to each other to form one turn (one round of the stator core) of the coil 3. More particularly, one turn of the coil 3 is formed by alternately joining odd-number-layer segment conductors and even-number-layer segment conductors, the respective conductor side portions 5 of which are disposed in layers that are adjacent to each other and in slots 22 located six slot pitches (one magnetic pole pitch) away from each other. The odd-number-layer segment conductors include the first-layer segment conductor 41, the third-layer segment conductor, the fifth-layer segment conductor, the seventh-layer segment conductor, and the ninth-layer segment conductor, and the even-number-layer segment conductors include the second-layer segment conductor 42, the fourth-layer segment conductor, the sixth-layer segment conductor, the eighth-layer segment conductor, and the tenth-layer segment conductor. For example, as shown in FIGS. 1 and 3, the first-layer segment conductor 41 and the second-layer segment conductor 42, the respective conductor side portions 5 of which are disposed in the slots 22 which are located six slot pitches away from each other, are joined to each other. A set of the plurality of first-layer segment conductors 41 and second-layer segment conductors 42 form one turn of the coil 3. In the embodiment, 48 slots 22 are formed in the stator core 2, and therefore one turn of the coil 3, which makes one round of (encircles) the stator core 2, is formed by alternately joining four first-layer segment conductors 41 and four second-layer segment conductors 42 to each other so as to encircle the stator core 2 in the circumferential direction C.

In the embodiment, in addition, the slots 22 for each of the phases (U-phase, V-phase, and W-phase) are disposed adjacent to each other in twos as described above, and therefore one turn of the coil 3 is formed for two slots 22 for each of the phases that are adjacent to each other and two adjacent layers in each of the slots 22. Hence, in the entire stator 1, four turns of the coil 3 for each of the phases, that is, a total of 12 turns of the coil 3, are formed by the first-layer segment conductors 41 and the second-layer segment conductors 42. This is the same for the other layers, and four turns of the coil 3 for each of the phases are formed for each of a set of the third-layer segment conductors and the fourth-layer segment conductors, a set of the fifth-layer segment conductors and the sixth-layer segment conductors, a set of the seventh-layer segment conductors and the eighth-layer segment conductors, and a set of the ninth-layer segment conductors and the tenth segment conductors. Respective turns of the coil 3 basically have the same shape as each other although the overall diameter of a turn is smaller as the layer in which the turn is disposed is more on the radially inward direction R1 side, and form a cylindrical wave-wound coil that encircles the stator core 2. In addition, respective turns of the coil 3 for each of the phases are distributed in two adjacent slots 22 that are located one slot pitch away from each other. That is, in the embodiment, the coil 3 is wound in the stator core 2 by distributed winding. Different turns of the coil 3 for the same phase are electrically connected in series or parallel with each other.

Next, the configuration of the plurality of segment conductors 4 forming the coil 3 will be described in detail with a focus on a set of the first-layer segment conductors 41 and the second-layer segment conductors 42 which are joined to each other. In FIG. 1, some of the first-layer segment conductors 41 and the second-layer segment conductors 42 are hatched with the second-layer segment conductors 42 more darkly hatched than the first-layer segment conductors 41. FIG. 3 shows the arrangement of some of the segment conductors 4 that correspond to such first-layer segment conductors 41 and second-layer segment conductors 42.

As shown in FIGS. 1 and 3, the first-layer segment conductor 41 is disposed with the parallel projecting portion 6 projecting toward the first axial direction L1 side of the stator core 2 and with the oblique projecting portion 7 projecting toward the second axial direction L2 side of the stator core 2. Meanwhile, the second-layer segment conductor 42 is disposed with the oblique projecting portion 7 projecting toward the first axial direction L1 side of the stator core 2 and with the parallel projecting portion 6 projecting toward the second axial direction L2 side of the stator core 2. Accordingly, the oblique projecting portion 7 of the second-layer segment conductor 42 is disposed adjacently on the radially inward direction R1 side of the parallel projecting portion 6 of the first-layer segment conductor 41 on the first axial direction L1 side, and the oblique projecting portion 7 of the first-layer segment conductor 41 is disposed adjacently on the radially outward direction R2 side of the parallel projecting portion 6 of the second-layer segment conductor 42 on the second axial direction L2 side. Thus, in the stator 1, the parallel projecting portion 6 of the first-layer segment conductor 41 and the oblique projecting portion 7 of the second-layer segment conductor 42 are joined to each other on the first axial direction L1 side with respect to the stator core 2, and the oblique projecting portion 7 of the first-layer segment conductor 41 and the parallel projecting portion 6 of the second-layer segment conductor 42 are joined to each other on the second axial direction L2 side with respect to the stator core 2. At this time, the joint portion 72 of the oblique projecting portion 7 of the first-layer segment conductor 41 is disposed to contact the parallel projecting portion 6 of the second-layer segment conductor 42 from the radially outward direction R2 side, and the joint portion 72 of the oblique projecting portion 7 of the second-layer segment conductor 42 is disposed to contact the parallel projecting portion 6 of the first-layer segment conductor 41 from the radially inward direction R1 side. More particularly, the joint portion 72 of the oblique projecting portion 7 of the first-layer segment conductor 41 is disposed at a position which is the same position in the circumferential direction C as the parallel projecting portion 6 of the second-layer segment conductor 42 and at which the oblique projecting portion 7 of the first-layer segment conductor 41 contacts the parallel projecting portion 6 of the second-layer segment conductor 42 from the radially outward direction R2 side, and the joint portion 72 of the oblique projecting portion 7 of the second-layer segment conductor 42 is disposed at a position which is the same position in the circumferential direction C as the parallel projecting portion 6 of the first-layer segment conductor 41 and at which the oblique projecting portion 7 of the second-layer segment conductor 42 contacts the parallel projecting portion 6 of the first-layer segment conductor 41 from the radially inward direction R1 side. Such a configuration is achieved by the setting of the length of the main portion 71 of the oblique projecting portion 7 in the circumferential direction C discussed above.

The joint portion provided at the distal-end portion of the parallel projecting portion 6 of each of the segment conductors 4 and the joint portion 72 of the oblique projecting portion 7 of the joint-target segment conductor are joined to each other to form an inter-segment joint portion. Hence, regarding the first-layer segment conductor 41 and the second-layer segment conductor 42, the joint portion of the parallel projecting portion 6 of the first-layer segment conductor 41 and the joint portion 72 of the oblique projecting portion 7 of the second-layer segment conductor 42 as the joint target are joined to each other to form an inter-segment joint portion on the first axial direction L1 side with respect to the stator core 2. Also, the joint portion of the parallel projecting portion 6 of the second-layer segment conductor 42 and the joint portion 72 of the oblique projecting portion 7 of the first-layer segment conductor 41 as the joint target are joined to each other to form an inter-segment joint portion on the second axial direction L2 side with respect to the stator core 2. In the embodiment, the plurality of inter-segment joint portions formed on both sides in the axial direction L with respect to the stator core 2 are all formed to have the same height in the axial direction L. The joint portion of the parallel projecting portion 6 and the joint portion 72 of the oblique projecting portion 7 may be joined to each other by arc welding such as TIG welding, electron beam welding, laser beam welding, resistance welding, brazing, or soldering, for example.

In the embodiment, in addition, the oblique projecting portion 7 of the first-layer segment conductor 41 and the oblique projecting portion 7 of the second-layer segment conductor 42 are shaped to extend toward the same side in the circumferential direction C of the core reference surface 21 as each of the oblique projecting portions 7 deviates from the stator core 2 in the axial direction L as seen from one side in the axial direction L of the core reference surface 21. That is, as shown in FIGS. 1 and 3, the oblique projecting portion 7 of the first-layer segment conductor 41 and the oblique projecting portion 7 of the second-layer segment conductor 42 are shaped to extend toward the first circumferential direction C1 side as each the oblique projecting portions 7 deviates from the stator core 2 in the axial direction L. The oblique projecting portion 7 of the second-layer segment conductor 42, which is disposed on the first axial direction L1 side of the stator core 2, is joined to the parallel projecting portion 6 of the first-layer segment conductor 41, and the oblique projecting portion 7 of the first-layer segment conductor 41, which is disposed on the second axial direction L2 side of the stator core 2, is joined to the parallel projecting portion 6 of the second-layer segment conductor 42. Accordingly, one turn of the coil 3 formed after joining such projecting portions has a wave-wound shape in which the oblique projecting portions 7, which serve as crossover portions that connect the conductor side portions 5 disposed in different slots 22 to each other, are alternately disposed on the first axial direction L1 side and on the second axial direction L2 side. Hence, each turn of the coil 3 is wound in the stator core 2 by wave winding.

In addition, as shown in FIG. 1, in the stator 1, the oblique projecting portion 7 of each the segment conductors 4 is disposed adjacently in parallel with and side by side at the same position in the radial direction as the oblique projecting portion 7 of the adjacent same-layer segment conductor. Thus, with a focus on the first-layer segment conductors 41, the oblique projecting portion 7 of each of the first-layer segment conductors 41 is disposed adjacently in parallel with and side by side at the same position in the radial direction as the oblique projecting portion 7 of another first-layer segment conductor 41, the conductor side portion 5 of which is disposed in an adjacent slot 22. Specifically, the oblique projecting portions 7 of the plurality of first-layer segment conductors 41 are disposed adjacent to each other with the main portions 71 extending in parallel with each other and arranged side by side at the same position in the radial direction as each other. Here, the phrase “side by side at the same position in the radial direction” refers to a state of being arranged at the same position in the radial direction R but consecutively displaced in the circumferential direction C. Accordingly, the oblique projecting portions 7 of the plurality of first-layer segment conductors 41 are disposed in a generally cylindrical shape. In other words, each of the oblique projecting portions 7 is disposed along a cylindrical surface that is parallel with the core reference surface 21. In the embodiment, the main portion 71 of each of the oblique projecting portions 7 is formed in the shape of an arc that is parallel with the core reference surface 21 as described above, and therefore the oblique projecting portions 7 of the plurality of first-layer segment conductors 41 are disposed in a cylindrical shape as a whole. In the embodiment, the main portions 71 of the oblique projecting portions 7 of two first-layer segment conductors 41 disposed in the slots 22 which are adjacent to each other are disposed to extend in parallel with each other at the same position in the radial direction R, and displaced one slot pitch away from each other in the circumferential direction C. Thus, the two main portions 71 are disposed side by side on a cylindrical surface, and disposed to overlap each other so as to face each other in the axial direction L in a portion of an area in the circumferential direction C in which the main portions 71 exist, specifically a center area in the circumferential direction C excluding an area corresponding to one slot pitch at each of end portions on the first circumferential direction C1 side and on the second circumferential direction C2 side. In the embodiment, the inclination angle of the extension direction of the main portion 71, which is bent at the first bent portion 73, is the same for all the first-layer segment conductors 41, and thus the main portions 71 of all the first-layer segment conductors 41 are disposed to extend in parallel with each other.

The configuration of the oblique projecting portions 7 described above is the same for the second-layer segment conductors 42. That is, as shown in FIG. 1 and as indicated by the double-dashed line in FIG. 3, the oblique projecting portion 7 of each of the second-layer segment conductors 42 is disposed adjacently in parallel with and at the same position in the radial direction as the oblique projecting portion 7 of another second-layer segment conductor 42, the conductor side portion 5 of which is disposed in the adjacent slot 22. Accordingly, the oblique projecting portions 7 of the plurality of second-layer segment conductors 42 are also disposed in a generally cylindrical shape. With the oblique projecting portions 7 of the segment conductors 4 in each of the layers configured as described above, the oblique projecting portions 7 of the plurality of segment conductors 4 can be disposed at a high density without processing the oblique projecting portions 7 or the like. Thus, it is possible to prevent the projecting portions (coil end portions) of the coil 3, which project from the stator core 2 in the axial direction L, from becoming large in the radial direction R and the axial direction L, which makes it possible to reduce the size of the stator 1.

The configuration of the plurality of segment conductors 4 has been described above with a focus on a set of the first-layer segment conductors 41 and the second-layer segment conductors 42 which are joined to each other. The configuration of the segment conductors 4 described above is the same for the third-layer segment conductors to the tenth-layer segment conductors. That is, for the segment conductors 4 in layers other than the first layer and the second layer, the segment conductors 4 in two layers that are adjacent to each other in the radial direction R are formed into a set. Such segment conductors 4 are formed to have the same shape and arrangement as the set of the first-layer segment conductors 41 and the second-layer segment conductors 42 discussed above except for the position in the radial direction R in the slots 22 and except that the overall diameter of the segment conductors 4 is smaller as the layer in which the segment conductors 4 are disposed is more on the radially inward direction R1 side. Hence, in the embodiment, the oblique projecting portions 7 of all the segment conductors 4 that are disposed in all the layers in the slots 22 are shaped to extend toward the same side in the circumferential direction C (here, toward the first circumferential direction C1 side) as the oblique projecting portions 7 deviate from the stator core 2 in the axial direction L. The set of segment conductors 4 in two layers that are adjacent to each other in the radial direction R are alternately joined to each other to form one turn (one round of the stator core) of the wave-wound coil 3.

In the embodiment, as described above, ten conductor side portions 5 are disposed side by side in a row in the radial direction R in each of the slots 22. Accordingly, in the configuration in which four or more conductor side portions 5 are disposed side by side in a row in the radial direction R in each of the slots 22, the plurality of parallel projecting portions 6 and the joint portions 72 of the plurality of oblique projecting portions 7 are disposed in a row to alternately appear along the radial direction R as shown in FIG. 1. More particularly, as shown in FIG. 1, on the first axial direction L1 side of the stator core 2, the parallel projecting portion 6, the joint portion 72 of the oblique projecting portion 7, the parallel projecting portion 6, . . . are alternately arranged in this order from the radially outward direction R2 side toward the radially inward direction R1 side. Meanwhile, on the second axial direction L2 side of the stator core 2, the joint portion 72 of the oblique projecting portion 7, the parallel projecting portion 6, the joint portion 72 of the oblique projecting portion 7, . . . are alternately arranged in this order from the radially outward direction R2 side toward the radially inward direction R1 side.
4. Manufacturing Method of Stator

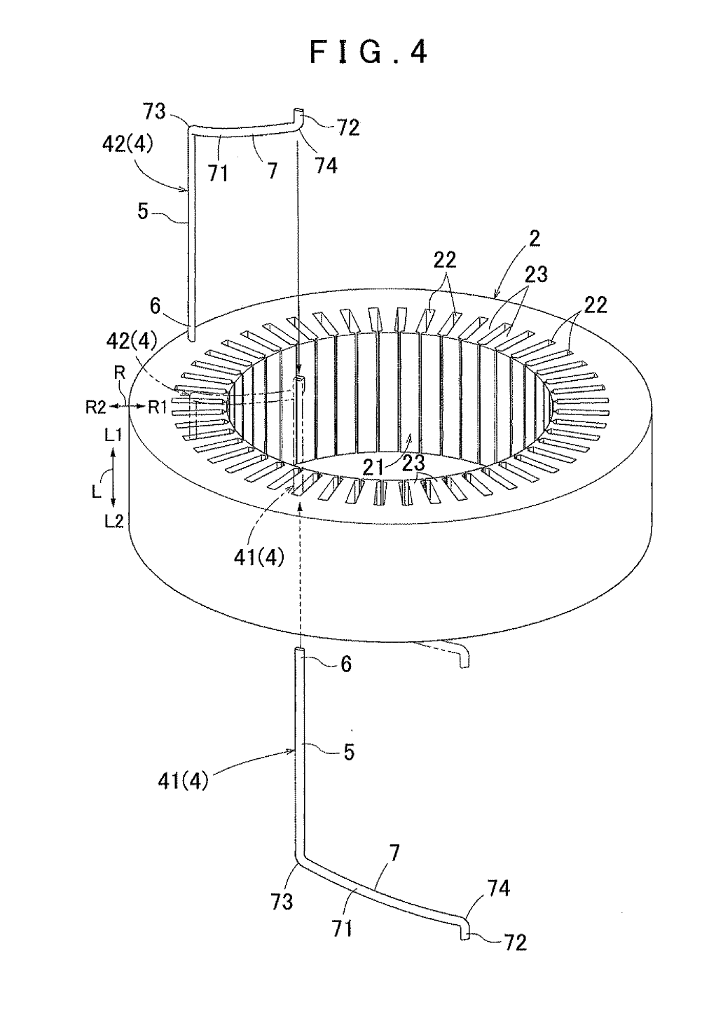

Next, the manufacturing method of the stator 1 according to the embodiment will be described. As described above, each of the segment conductors 4 includes the oblique projecting portion 7 provided only on one side in the axial direction L with respect to the conductor side portion 5, and the parallel projecting portion 6 provided on the other side in the axial direction L. The parallel projecting portion 6 is formed to extend in parallel with the extension direction of the conductor side portion 5 at the same position in the circumferential direction C as the conductor side portion 5, and therefore can be easily inserted into the slot 22, which is formed in the shape of a groove extending in the axial direction L and the radial direction R, along the axial direction L, as with the conductor side portion 5. Thus, when mounting the segment conductors 4 to the stator core 2, each of the segment conductors 4 is inserted into the slot 22 along the axial direction L with the parallel projecting portion 6 at the leading head. For example, in the configuration according to the embodiment, as shown in FIG. 4, the first-layer segment conductor 41 is inserted into the slot 22 of the stator core 2 along the axial direction L from the second axial direction L2 side with the parallel projecting portion 6 at the leading head on the first axial direction L1 side. Also, the second-layer segment conductor 42 is inserted into the slot 22 of the stator core 2 along the axial direction L from the first axial direction L1 side with the parallel projecting portion 6 at the leading head on the second axial direction L2 side. Also for the other layers, the odd-number-layer segment conductors are inserted in the same way as the first-layer segment conductor 41, and the even-number-layer segment conductors are inserted in the same way as the second-layer segment conductor 42.

In addition, although not shown, when inserting the segment conductors 4 into the slots 22, it is necessary to insert all the segment conductors 4 forming the respective layers, at least those forming each of the layers, at a time. This is because the oblique projecting portions 7 of the plurality of segment conductors 4 in the same layer are disposed to be stacked on each other in the axial direction L at the same position in the radial direction while being displaced one slot pitch away from each other in the circumferential direction C, and thus inserting only some of the segment conductors 4 forming the same layer into the slots 22 in advance makes it difficult to insert the remaining segment conductors 4 due to interference by the oblique projecting portions 7. Thus, in the embodiment, before insertion into the slots 22, all the segment conductors 4 forming the same layer are first assembled to each other to have the same positional relationship as the positional relationship after insertion into the slots 22 in order to form a sub-assembly. Thereafter, all the segment conductors 4 forming the same layer in the form of a sub-assembly are inserted into the slots 22 at the same time to assemble the segment conductors 4 to the stator core 2. Such a sub-assembly can be formed by holding all the segment conductors 4 forming the same layer at respective predetermined positions using a jig or the like, for example. Such a sub-assembly may be formed for each of the layers, or collectively for a plurality of layers. In the case where a sub-assembly is formed collectively for a plurality of layers, for example, all the segment conductors 4 that are to be inserted into the slots 22 from the first axial direction L1 side (all the even-number-layer segment conductors) may be collectively formed into a sub-assembly. Likewise, all the segment conductors 4 that are to be inserted into the slots 22 from the second axial direction L2 side (all the odd-number-layer segment conductors) may be collectively formed into a sub-assembly. In any case, each sub-assembly is formed such that all the segment conductors 4 forming that sub-assembly take the same positional relationship as the positional relationship after insertion into the slots 22.

In the stator 1 according to the embodiment, as described above, each of the segment conductors 4 includes the parallel projecting portion 6 provided on one side of the straight conductor side portion 5 in the axial direction L, and the parallel projecting portion 6 is formed to extend in parallel with the extension direction of the conductor side portion 5 at the same position in the circumferential direction C as the conductor side portion 5. Therefore, the segment conductors 4 can be easily inserted into the slots 22 in the axial direction L. Thus, it is possible to simplify the process of inserting the segment conductors 4 into the slots 22. In addition, it is not necessary to provide the slots 22 of the stator core 2 with an opening for insertion of the segment conductors 4 from the radially inward direction R1 side. Therefore, it is possible to enhance the degree of freedom in shape of the slots 22. Further, after all the segment conductors 4 are inserted into the slots 22, the joint portion 72 of the oblique projecting portion 7 of each of the segment conductors 4 is disposed at a position at which the joint portion 72 contacts the parallel projecting portion 6 of the joint-target segment conductor. Therefore, the plurality of segment conductors 4 can be joined to each other to form the coil 3 without processing, such as bending, the segment conductors 4 after being inserted into the slots 22. Thus, it is possible to simplify the manufacturing process of the stator 1 and to reduce the manufacturing cost also in this respect.

The present invention can be suitably utilized for a rotary electric machine armature including an armature core and a coil wound in the armature core.

What is claimed is:

1. A rotary electric machine armature, comprising:
an armature core in which a plurality of slots extending in an axial direction of a cylindrical core reference surface are distributed in a circumferential direction of the core reference surface and a coil wound in the armature core, wherein
the coil is formed by joining a plurality of segment conductors to each other;
each of the segment conductors includes a straight conductor side portion disposed in the slot, a parallel projecting portion extending in parallel with an extension direction of the conductor side portion to project in the axial direction from the armature core, and an oblique projecting portion provided opposite the parallel projecting portion in the axial direction and extending from the conductor side portion to project in the axial direction from the armature core, the oblique projecting portion being inclined in the circumferential direction with respect to the extension direction of the conductor side portion so as to gradually deviate from the armature core in the axial direction, and the oblique projecting portion extending from the conductor side portion to the parallel projecting portion of a joint-target segment conductor, which is another of the segment conductors as a joint target;
a distal-end portion of the oblique projecting portion is joined to the parallel projecting portion of the joint-target segment conductor; and
another of the segment conductors, the conductor side portion of which is disposed at the same position in a radial direction in an adjacent slot, serves as an adjacent same-layer segment conductor, and the oblique projecting portion of each of the segment conductors is disposed adjacently in parallel with and side by side at the same position in the radial direction as the oblique projecting portion of the adjacent same-layer segment conductor.

2. The rotary electric machine armature according to claim 1, wherein
one side and the other side of the core reference surface in the axial direction serve as a first axial direction side and a second axial direction side, respectively, and the segment conductor, the conductor side portion of which is disposed in a first layer provided at a predetermined position in the radial direction in the slot serves as a first-layer segment conductor, and the segment conductor, the conductor side portion of which is disposed in a second layer provided adjacently on a radially inner side with respect to the first layer serves as a second-layer segment conductor, and
the parallel projecting portion of the first-layer segment conductor and the oblique projecting portion of the second-layer segment conductor are joined to each other on the first axial direction side with respect to the armature core, and the oblique projecting portion of the first-layer segment conductor and the parallel projecting portion of the second-layer segment conductor are joined to each other on the second axial direction side with respect to the armature core.

3. The rotary electric machine armature according to claim 2, wherein
the oblique projecting portion of the second-layer segment conductor is disposed adjacently on a radially inner side of the parallel projecting portion of the first-layer segment conductor on the first axial direction side, and
the oblique projecting portion of the first-layer segment conductor is disposed adjacently on a radially outer side of the parallel projecting portion of the second-layer segment conductor on the second axial direction side.

4. The rotary electric machine armature according to claim 2, wherein
the first-layer segment conductor is inserted into the slot of the armature core along the axial direction from the second axial direction side with the parallel projecting portion at a leading head on the first axial direction side; and
the second-layer segment conductor is inserted into the slot of the armature core along the axial direction from the first axial direction side with the parallel projecting portion at a leading head on the second axial direction side.

5. The rotary electric machine armature according to claim 2, wherein
the oblique projecting portion of the first-layer segment conductor and the oblique projecting portion of the second-layer segment conductor are shaped to extend toward the same side in the circumferential direction of the core reference surface as each of the oblique projecting portions deviates from the armature core in the axial direction as seen from one side in the axial direction of the core reference surface.

6. The rotary electric machine armature according to claim 1, wherein
the parallel projecting portion is formed in a shape of a straight line that is disposed on an extension line of the conductor side portion.

7. The rotary electric machine armature according to claim 1, wherein
the oblique projecting portion includes a joint portion to be joined to the parallel projecting portion of the joint-target segment conductor,
the joint portion is formed to contact the parallel projecting portion of the joint-target segment conductor from one side in the radial direction, and to extend in parallel with an extension direction of the parallel projecting portion at the same position in the circumferential direction as the parallel projecting portion, and
a main portion of the oblique projecting portion is formed in a shape of a straight line that extends in an inclined direction with respect to the extension direction of the conductor side portion as seen in the radial direction of the core reference surface, and in a shape of an arc that is parallel with the core reference surface as seen in the axial direction of the core reference surface.

8. The rotary electric machine armature according to claim 2, wherein
the parallel projecting portion is formed in a shape of a straight line that is disposed on an extension line of the conductor side portion.

9. The rotary electric machine armature according to claim 2, wherein
the oblique projecting portion includes a joint portion to be joined to the parallel projecting portion of the joint-target segment conductor,
the joint portion is formed to contact the parallel projecting portion of the joint-target segment conductor from one side in the radial direction, and to extend in parallel with an extension direction of the parallel projecting portion at the same position in the circumferential direction as the parallel projecting portion, and
a main portion of the oblique projecting portion is formed in a shape of a straight line that extends in an inclined direction with respect to the extension direction of the conductor side portion as seen in the radial direction of the core reference surface, and in a shape of an arc that is parallel with the core reference surface as seen in the axial direction of the core reference surface.

10. The rotary electric machine armature according to claim 3, wherein
the first-layer segment conductor is inserted into the slot of the armature core along the axial direction from the second axial direction side with the parallel projecting portion at a leading head on the first axial direction side; and
the second-layer segment conductor is inserted into the slot of the armature core along the axial direction from the first axial direction side with the parallel projecting portion at a leading head on the second axial direction side.

11. The rotary electric machine armature according to claim 3, wherein
the oblique projecting portion of the first-layer segment conductor and the oblique projecting portion of the second-layer segment conductor are shaped to extend toward the same side in the circumferential direction of the core reference surface as each of the oblique projecting portions deviates from the armature core in the axial direction as seen from one side in the axial direction of the core reference surface.

12. The rotary electric machine armature according to claim 3, wherein
the parallel projecting portion is formed in a shape of a straight line that is disposed on an extension line of the conductor side portion.

13. The rotary electric machine armature according to claim 3, wherein
the oblique projecting portion includes a joint portion to be joined to the parallel projecting portion of the joint-target segment conductor,
the joint portion is formed to contact the parallel projecting portion of the joint-target segment conductor from one side in the radial direction, and to extend in parallel with an extension direction of the parallel projecting portion at the same position in the circumferential direction as the parallel projecting portion, and
a main portion of the oblique projecting portion is formed in a shape of a straight line that extends in an inclined direction with respect to the extension direction of the conductor side portion as seen in the radial direction of the core reference surface, and in a shape of an arc that is parallel with the core reference surface as seen in the axial direction of the core reference surface.

14. The rotary electric machine armature according to claim 6, wherein
the oblique projecting portion includes a joint portion to be joined to the parallel projecting portion of the joint-target segment conductor,
the joint portion is formed to contact the parallel projecting portion of the joint-target segment conductor from one side in the radial direction, and to extend in parallel with an extension direction of the parallel projecting portion at the same position in the circumferential direction as the parallel projecting portion, and
a main portion of the oblique projecting portion is formed in a shape of a straight line that extends in an inclined direction with respect to the extension direction of the conductor side portion as seen in the radial direction of the core reference surface, and in a shape of an arc that is parallel with the core reference surface as seen in the axial direction of the core reference surface.

15. The rotary electric machine armature according to claim 4, wherein
the oblique projecting portion of the first-layer segment conductor and the oblique projecting portion of the second-layer segment conductor are shaped to extend toward the same side in the circumferential direction of the core reference surface as each of the oblique projecting portions deviates from the armature core in the axial direction as seen from one side in the axial direction of the core reference surface.

16. The rotary electric machine armature according to claim 4, wherein
the parallel projecting portion is formed in a shape of a straight line that is disposed on an extension line of the conductor side portion.

17. The rotary electric machine armature according to claim 4, wherein
the oblique projecting portion includes a joint portion to be joined to the parallel projecting portion of the joint-target segment conductor,
the joint portion is formed to contact the parallel projecting portion of the joint-target segment conductor from one side in the radial direction, and to extend in parallel with an extension direction of the parallel projecting portion at the same position in the circumferential direction as the parallel projecting portion, and
a main portion of the oblique projecting portion is formed in a shape of a straight line that extends in an inclined direction with respect to the extension direction of the conductor side portion as seen in the radial direction of the core reference surface, and in a shape of an arc that is parallel with the core reference surface as seen in the axial direction of the core reference surface.

18. The rotary electric machine armature according to claim 10, wherein
the oblique projecting portion of the first-layer segment conductor and the oblique projecting portion of the second-layer segment conductor are shaped to extend toward the same side in the circumferential direction of the core reference surface as each of the oblique projecting portions deviates from the armature core in the axial direction as seen from one side in the axial direction of the core reference surface.

19. The rotary electric machine armature according to claim 10, wherein
the parallel projecting portion is formed in a shape of a straight line that is disposed on an extension line of the conductor side portion.

20. The rotary electric machine armature according to claim 10, wherein
the oblique projecting portion includes a joint portion to be joined to the parallel projecting portion of the joint-target segment conductor,
the joint portion is formed to contact the parallel projecting portion of the joint-target segment conductor from one side in the radial direction, and to extend in parallel with an extension direction of the parallel projecting portion at the same position in the circumferential direction as the parallel projecting portion, and
a main portion of the oblique projecting portion is formed in a shape of a straight line that extends in an inclined direction with respect to the extension direction of the conductor side portion as seen in the radial direction of the core reference surface, and in a shape of an arc that is parallel with the core reference surface as seen in the axial direction of the core reference surface.
